(19) United States
(12) Patent Application Publication
(10) Pub. No.: US 2023/0264051 A1
(43) Pub. Date: Aug. 24, 2023

(54) HOUSING AND BLOWER FILTER UNIT WITH ONE HOUSING

(71) Applicant: Dräger Safety AG & Co. KGaA, Lübeck (DE)

(72) Inventor: Timo TRALAU, Lübeck (DE)

(21) Appl. No.: 18/169,267

(22) Filed: Feb. 15, 2023

(30) Foreign Application Priority Data
Feb. 18, 2022 (DE) 10 2022 103 863.7

(51) Int. Cl. A62B 18/00; A62B 7/10; A62B 7/12; A62B 18/08

(52) U.S. Cl. CPC A62B 18/006; A62B 7/10; A62B 7/12; A62B 18/08

(57) ABSTRACT

A housing (1) accommodates various electrical, electronic, electromechanical and/or electropneumatic components (13) in a housing interior (2). A blower filter unit (19) is provided with such a housing (1). The housing (1) has at least one housing through-opening (4), arranged between the housing interior (2) and a housing environment (3), for receiving at least one functional unit (6) which, in a state received in the housing through-opening (4) is connectable to at least one of the components (13) arranged in the housing interior (2) for transmitting data, signals and/or power. The functional unit (6) is provided as an adapter module (9), which has a connector (10) that can be non-destructively detachably connected to a contact element (5) arranged in the housing through-opening (4), establishing a connection for transmitting the data, signals and/or power.

### CROSS REFERENCE TO RELATED APPLICATIONS

This application claims the benefit of priority under 35 U.S.C. §119 of German Application 10 2022 103 863.7, filed Feb. 18, 2022, the entire contents of which are incorporated herein by reference.

### TECHNICAL FIELD

The invention relates to a housing for accommodating various components and to a blower (fan) filter device having such a housing. The housing has a housing interior in which various electrical, electronic, electromechanical and/or electropneumatic components are arranged, and at least one housing passage through-opening between the housing interior and a housing environment. In this case, the housing passage through-opening is suitable for accommodating an operating status display, an control element for initiating a switch-on or switch-off process and a contact element for forwarding data, signals and/or power (energy) to at least one of the components arranged in the housing interior.

### BACKGROUND

Various housings are known from the prior art which suitably accommodate the respective components required in their housing interior. The known housings always have housing through-openings in which externally accessible components, such as a charging socket, can be connected to an external power supply unit. Likewise, display or control elements are arranged in such housing through-openings, which output information about an operating state of the device or enable operation of the components arranged in the interior of the housing.

The elements arranged in the housing passage openings are each arranged in the housing passage in such a way that, depending on the respective requirements, a dust-tight, liquid-tight or gas-tight seal is ensured between the interior of the housing and the environment. At the same time, these elements, in particular an operating status display, a control element for switching the device on and off, or a charging socket for forwarding power or data, must be arranged in the housing wall in such a way that they can be seen from the outside or are freely accessible to a user without problems, at least at times, these elements being connected to different components in the housing interior, such as a control unit and/or a drive motor. Among other things, in the case of so-called blower filter units (or powered air purifying respirator -- PAPR), which are used in areas where toxic, flammable and/or explosive gas mixtures may be present, suitable sealing of the respective housing through-openings is provided in order to reliably prevent the transport of potentially harmful media into the housing interior. In addition, contamination of the elements accessible from the outside of the housing wall, in particular the contact elements such as charging sockets for forwarding data, signals or power, is sometimes a not inconsiderable problem. For this reason, additional cover caps or lids are often provided to protect these contact elements, which are accessible from the outside, from contamination during the use of a device.

The elements arranged on the outside of a housing wall, such as operating status display, control elements and contact elements, are generally firmly connected to the housing wall in known device housings and are each individually sealed. Due to these separate sealing points, there is a relatively high risk of leaks occurring with regard to the sealing of the device.

A blower filter device that has a generic housing is known from DE 10 2016 009 486 A1. In operation, this device, which is worn on the body with the aid of a carrying strap, draws in ambient air from the environment, cleans the ambient air of harmful gases in a filter arranged in the interior of the housing, and supplies the cleaned air to the device wearer via a hose and a suitable interface, which is arranged, for example, in a head hood. The interior of the housing of the blower filter unit contains the components required for operation, in particular the blower, filter, hose, data and power lines, energy storage and a control unit. On the outside of the housing there is, among other things, an operating status display, by which the user is informed about the operating status of the device, as well as a control element for switching the blower filter device on and off. Furthermore, a contact element in the form of a charging socket is provided in the housing wall, which enables the connection of an external unit for supplying the blower filter unit with power, but also the transfer of data, in particular the uploading of software and firmware updates.

A usual arrangement has a housing with a housing wall with an operating status display, an control element for switching a device on and off and a contact element in the form of a charging socket, via which power and/or data are transmitted to at least one component in the interior of the housing. Three housing through-openings are provided in the housing wall for the three elements: the operating status indicator; the control element and the contact element, in which the respective element is arranged and correspondingly sealed with respect to the housing wall. Due to the seals of the individual components, there is a relatively high risk for the occurrence of a leak with respect to the overall device, for example for a blower filter device.

Furthermore, the contact element of the device with such a usual arrangement is not protected against contamination or the effects of weather. To ensure appropriate protection, additional elements, such as a cover cap, must be provided.

### SUMMARY

Based on the device housings known from the prior art, in particular the housings of blower filter devices, the invention is based on the object of further configuring these in such a way that the sealing surfaces present in the required housing passage openings are reduced to a minimum. This is intended to minimize both the effort required to produce the seals and the risk of leaks occurring, and thus the risk of damage to the equipment and accidents.

At the same time, the solution to be specified should enable safe and easy operation of the device for the user.

In addition, it should be ensured by relatively simple means that the risk of contamination of the elements accessible from the outside, in particular the contact elements for the forwarding of data, signals and/or power, is significantly reduced during the use of a device, whereby additionally required cover elements should be dispensed with. In this context, it is further desirable if it is possible for a device to be operated only if a corresponding contact element is reliably protected against contamination.

The aforementioned task is solved with a housing with features according to the invention and a blower filter device with features according to the invention. A process for operating an apparatus by which the aforementioned task is solved is provided based on features according to the invention.

The invention relates to a housing for accommodating various electrical, electronic, electromechanical and/or electropneumatic components in a housing interior, having at least one housing through-opening arranged between the housing interior and a housing environment for accommodating a functional unit which, in a state accommodated by the housing through-opening, can be connected or is connected to at least one of the components arranged in the housing interior for the transmission of data, signals and/or power. According to the invention, the housing is further formed in that the functional unit is attached to an adapter module which has a connector which can be non-destructively detachably connected to a contact element arranged in the housing through-opening while establishing a connection for transmitting the data, signals and/or power. The invention is thus essentially characterized in that, in order to establish the necessary connection between the at least one functional unit, preferably a plurality of functional units, and the components arranged in the interior of the housing, which connection is required for the transmission of data, signals and/or power, only one housing through-opening is provided, which must be sealed accordingly. The number of sealing points required, and the size of the sealing surfaces are thus significantly reduced compared to technical solutions known from the prior art. This is achieved by the adapter module provided in accordance with the invention, in which in principle any number of different functional units can be integrated and which can be connected via its connector to the contact element arranged in the housing through-opening, for example a socket with metallic contact pins, and can also be separated from the latter again in a non-destructive manner. The at least one functional unit can thus be connected to the contact element for indirect data, signal and/or power transmission. The contact element is only freely accessible from the outside if the adapter module with the functional unit has been removed from the contact element, i.e. the connection between the contact element and the connector of the adapter module has been disconnected.

According to a preferred embodiment, the contact element is a socket with a plurality of electrically conductive metal pins, while the connector of the adapter module has suitable sleeve-like receptacles that can be plugged onto the pins to form an electrically conductive connection.

Before the device is put into operation, the connector of the adapter module with the functional unit is fastened to the contact element. Advantageously, the adapter module has an outer contour that can be inserted into a suitable receiving contour of the housing wall so that the housing wall and the outer surface of the adapter module are in contact at least in some areas.

The sealing between an outer surface of the contact element and an inner wall of the housing through-opening is carried out in such a way that the respective required sealing is realized. Depending on the requirements of the respective device during its use, this seal is preferably configured to be dust-tight, liquid-tight or air- or gas-tight. Likewise, at least one suitable sealing element can be provided between the adapter module and the housing wall, for example to ensure a dust-tight seal of the contact element with respect to the housing environment.

According to a particular embodiment of the invention, it is provided that in a state in which the adapter module is received by the housing through-opening due to the connection of the contact element and the connector, a gas-tight seal is ensured between the housing interior and the housing environment. Particularly taking into account economic aspects, that the housing through-opening, the contact element and/or the adapter module may be configured in such a way only the sealing that is absolutely necessary due to the intended use, i.e. for example a dust-tight or liquid-tight seal, is realized.

The functional unit within the meaning of the invention can generally be any unit, in particular an electrical or electronic component, which performs a required function for the operation of a device. It is conceivable in this context that a functional unit is an energy storage device, for example a battery (an accumulator) or capacitor, a printed circuit board, a data memory, in particular for storing software or firmware, a drive unit, a blower motor, a filter, an operating status display, an control element for initiating a switch-on or switch-off process of at least one of the components and/or a display element, for example a display. According to the invention, the respective functional unit is integrated in the adapter module or at least connected thereto and can be connected together with the adapter module via the connector to the contact element arranged in the housing through-opening, wherein a connection for forwarding data, signals and/or power is established between the contact element and the connector of the adapter module.

In a special embodiment of the invention, the functional unit has at least one operating status display and one control element for switching on and off, i.e. for switching on and off, at least one of the components arranged in the interior of the housing. In this case, at least one operating status display and one control element are thus connected to the adapter module and an exchange of data and/or signals with at least one component arranged in the interior of the housing and/or a supply of power can take place at least indirectly via the contact element.

In a further embodiment, the operating status display is integrated into the control element. Preferably, the control element in this case has a pressure-sensitive and/or touch-sensitive area and an indicator element, for example in the form of an LED, which forms the operating status display. According to a very special further development, the operating status display is integrated into the pressure-sensitive and/or touch-sensitive area, which may comprise a pressure switch. In any case, the operating status display and the control element are in turn integrated into the adapter module in a suitable manner, so that unidirectional or bidirectional transmission of data and/or signals between at least one of the components arranged in the interior of the housing and the operating status display and/or the control element is also possible. It is particularly advantageous if a data, signal and/or power transmission path can be established at least temporarily via the connector of the adapter module and the contact element connected to the connector between a control unit and/or drive unit arranged in the housing interior, for example a blower motor, and the operating status display and/or the control element.

Further, it is advantageously provided that the housing has at least one air inlet and at least one air outlet. In this case, the air inlet serves to supply air from the environment, for example contaminated air of a production area, into the interior of the housing, while the air outlet is configured for at least indirect connection of a breathing air hose or tube to a housing wall. Via the air inlet, ambient air is introduced into flow lines, which are arranged in the housing interior, and is thereby conducted to at least one treatment unit, in particular a filter. Following the required treatment, in particular filtration, of the air, the treated air is in turn conveyed by means of the blower provided in the device through hose lines and/or pipe lines to the air outlet and from there discharged again from the housing interior. Via a breathing air hose or pipe connected to the air outlet, the treated air is supplied to an equipment wearer who, for example, wears a helmet or a hood with a hose connection nozzle.

In a further particular embodiment of the invention, it is provided that at least one fastening element for at least indirect fastening of a belt and/or a carrying strap is arranged on a housing wall. Preferably, the fastening element has a hook, a buckle and/or a strap, so that a belt or carrying strap can be fastened thereto and, preferably, can be changed in length. This is particularly advantageous if the housing is a housing of a device carried by the user during use, for example a blower filter device.

To enable suitable fastening of the adapter module in the area of the housing through-opening to the housing wall, which can also be released without tools or destruction, it is advantageous if a thread, a latching element, a recess and/or another suitable connector structure is provided in the area of the housing through-opening. In this case, the adapter module has a suitable mating contour, for example in the form of a suitable external contour, an external thread, a latching lug or a movable element, for example spring-loaded element, which can be fastened at least indirectly to the housing wall in the region of the housing through-opening and released again without the use of a tool.

Furthermore, it is conceivable in an advantageous manner that the housing wall in the area of the housing through-opening has a receptacle which is at least partially conical and/or undersized with respect to an outer diameter of the adapter module. According to this embodiment, a suitable connection between the adapter module and the housing wall in the region of the housing through-opening is achieved by, for example, implementing an interference fit between the adapter module receiving surface formed by the housing wall and the adapter module.

It is also advantageous to arrange at least one sealing element on the housing wall in the area of the housing opening and/or on the adapter module. The sealing element(s) is/are configured in such a way that the required seal between the connector and contact element on the one hand and the housing environment on the other, i.e. optionally a dust-tight, liquid-tight, air-tight or gas-tight seal, is produced.

According to a further advantageous embodiment of the adapter module, it is provided that a line for transmitting data, signals and/or power is arranged between the connector and an outer adapter contact element arranged on the opposite side. According to this embodiment, the adapter module, in a state in which it is inserted into the housing through-opening, has an adapter contact element on the outer side facing the environment, which can preferably be closed with a cover or a cap. The adapter contact element has a contact structure, preferably a plurality of metal pins, and is suitable for passing on data, signals and/or power received from an external supply unit into the adapter module, in particular the line provided herein, so that the data, signals and/or power can finally be transmitted via the connector of the adapter module into the contact element connected thereto. According to this embodiment, it is thus possible to transmit data, signals and/or power unidirectionally or bidirectionally between the outer contact element of the adapter module and the contact element arranged in the housing through-opening of the housing wall.

Further, the invention also relates to a blower filter device with a housing which is formed according to at least one of the embodiments described above. In particular, the blower filter device has an air inlet for supplying air from the environment into the housing interior and an air outlet for discharging air from the housing interior, wherein at least data, signal and/or power transmission paths, a control unit for generating a control signal for actuating at least one of the components, an energy storage device and, between the air inlet and the air outlet, elements for guiding air, at least one air conveying unit and a filter for treating the air from the environment are arranged in the housing interior. The blower filter device according to the invention thus has a housing with a housing through-opening in which a contact element is located, which in turn is connectable to the connector of an adapter module having at least one functional unit. The functional unit, which has, for example, an operating status display and a control element for switching on or off at least one of the components arranged in the interior of the housing, is preferably connected to the contact element by non-destructively detachably inserting the connector of the adapter module into the contact element for transmitting the data, signals and/or power. Thus, it is again essential that the housing of the blower filter unit has a housing through-opening in which there is a contact element, in particular a socket, which accommodates an adapter module with a functional unit at least during operation. The functional unit has, for example, an energy storage device, in particular a battery (an accumulator) or capacitor, a drive unit, a blower motor, a filter, an operating status display, a control element for initiating a switch-on or switch-off process of at least one of the components, and/or a display element, such as a display. When the adapter module is connected, data, signals and/or power are again transmitted between the functional unit and at least one of the components arranged in the interior of the housing via the contact element and the connector of the adapter module.

According to a preferred further development of the invention, the functional unit has at least one operating status display as well as a control element for switching at least one of the components on and off in the housing interior. In this case, the operating status display and the control element are arranged in an adapter module, which can be connected or is connected by its connector to the contact element arranged in the housing through-opening, the respectively required sealing being realized both between the contact element and the housing wall and between an outer surface of the adapter module and the housing wall in the region of the housing through-opening. In this context, it is particularly advantageous that the housing through-opening and, in particular, the contact element arranged therein are covered by the adapter module when the blower filter unit is put into operation, so that the contact element is reliably protected from contamination and the effects of the weather. The operating status display and the control element are arranged in the adapter module in such a way that they can be seen from the outside and are freely accessible to the device carrier.

In a special further development of the invention, it is provided that a potting compound is arranged in at least some areas of the interior of the housing. Alternatively or in addition, it can be provided that components in the form of protective circuits are provided in the housing interior, which ensure that no excessive currents and/or electrical voltages are generated in the electronic circuits. A blower filter unit equipped in this way is suitable for use in so-called explosion-proof areas, i.e. in particular production areas in which explosive gas mixtures can form. Furthermore, at least one sealing element and/or a sealing structure may be provided between the contact element and the inner wall of the housing passage opening and/or between the adapter module and the housing wall in the area of the housing passage opening, which ensures an air-tight or gas-tight seal of the housing interior, in particular of the components arranged in this housing interior, with respect to an environment. In this context, it is advantageous if at least one sealing element is provided on an outer surface of the adapter module, on the housing wall and/or inside the housing through-opening, by means of which the respectively required sealing between the housing interior and the environment, i.e. a dust-tight, liquid-tight or gas-tight sealing, is ensured.

According to a special further development of the invention, it is provided that the adapter module of the blower filter device has at least one identification unit, for example a suitable transponder, via which a proper fit of the adapter module in the contact element and/or relative to the housing passage opening and/or an identity of the adapter module can be detected by the control unit, which is arranged in the housing interior. In this case, the control unit detects the proper fit, possibly with the required sealing of the adapter module, and/or the use of the correct adapter module. A corresponding design of a blower filter unit thus represents an advantageous further development both in terms of the safety of the equipment carrier and the use of the actually suitable adapter module in each case.

Further, in a special further development of the invention, the adapter module has at least one transceiver unit for at least partial transmission and/or reception of wirelessly transmitted signals. In this case, the transceiver unit arranged in or on the adapter module preferably enables wireless unidirectional or bidirectional transmission of signals or data between at least one component arranged in the interior of the housing and a signal and data processing unit arranged outside the blower filter unit.

In a particular embodiment, it is further provided that at least one signal, data and/or power transmission path is provided within the adapter module, via which data, signals and/or power can be transmitted between an outer adapter contact element and the connector of the adapter module in a wireless or wired manner. As soon as the adapter module is in a properly inserted state in the housing through-opening, data, signals and/or power can thus be transmitted from the outer adapter contact element via the transmission path to the connector and via this ultimately to the contact element arranged in the housing through-opening. In this case, the adapter module is configured in such a way that data, signals and/or power can be transmitted via the transmission path through the adapter module.

Furthermore, the invention also relates to a process for putting into operation an apparatus having a housing for accommodating various electrical, electronic, electromechanical and/or electropneumatic components in a housing interior with at least one housing through-opening arranged between the housing interior and the housing environment for accommodating a functional unit, which has, for example, an operating state display and an control element for initiating a switching-on or switching-off process of at least one of the components and a contact element for forwarding data, signals and/or power to at least one of the components arranged in the housing interior, and which is configured to transmit data, signals and/or power to at least one of the components arranged in the housing interior. The process according to the invention is characterized in that an adapter module comprising the functional unit and a connector is provided, and the connector is non-destructively detachably attached to a contact element arranged in the housing through-hole in such a way that a connection is established for transmitting the data, signals and/or power. The contact element arranged in the housing through-opening thus serves as a suitable receptacle for fastening the connector of the adapter module. At the same time, the contact element is covered in such a way that it is reliably protected from contamination and weathering underneath the adapter module.

According to a special further development of the process according to the invention, it is provided that data, signals and/or power are transmitted at least intermittently via the adapter module to at least one of the components arranged in the interior of the housing. This transmission takes place when the control element is actuated, either by forwarding signals to the operating status display, and/or by transmitting data. The transmission can be wired or wireless via a transceiver unit arranged within the adapter module. It can also be advantageous to provide an external adapter contact element on the adapter module, preferably with a plurality of metal pins, via which data, signals and/or power can be transmitted from an external power and/or control unit via the adapter module to at least one of the components arranged in the housing interior.

In the following, without limiting the general idea of the invention, the invention is explained in more detail by means of specific embodiments with reference to the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional view showing a housing with a housing wall having a through-opening and with a contact element for connection to an external power supply and showing an adapter module with an operating status display and a control element; and

FIG. 2 is a perspective partially schematic view of a blower filter unit with housing configured according to the invention.

### DESCRIPTION OF PREFERRED EMBODIMENTS

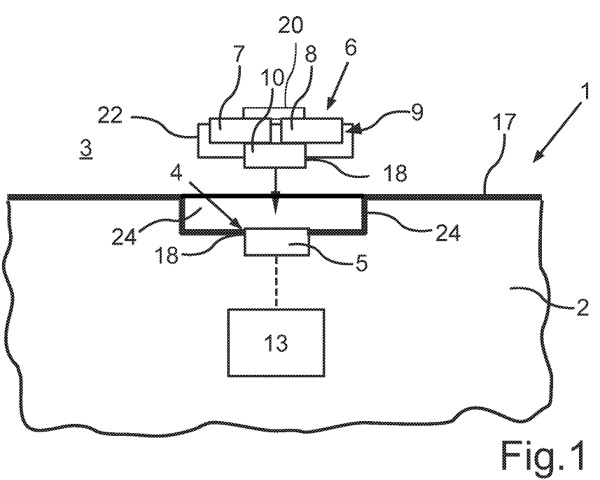

FIG. 1 shows in a schematic sectional view a part of a housing 1 configured according to the invention. In FIG. 1, an adapter module 9 is shown with a functional unit 6, which has an operating status display 7, a control element 8 for switching a device on and off, and a connector 10. In this case, the device is a blower filter device 19 that includes the housing 1. The connector 10 can be connected to a contact element 5 in the form of a charging socket arranged in a housing through-opening 4, which is provided for forwarding data, signals and/or power to at least one component 13 in the housing interior 2. It is essential that a separate adapter module 9 is provided, in which both the operating status display 7 and the control element 8 are arranged, and which also has a connector 10 which can be inserted into the contact element 5, in particular a contact element socket with metallic contact pins (contacts). A connection is produced between the adapter module 9 and the contact element 5 arranged in the housing through-opening 4 of a housing wall (a housing wall structure) 17 which can be detached without tools or destruction. The housing wall 17 is further shaped in the region of the housing through-opening 4 in such a way that the outer contour 22 of the adapter module 9 can be inserted into the outer edge wall contour 24 formed by the housing wall 17, and the housing wall 17 and the outer surface 22 of the adapter module 9 are at least partially in contact.

In the area of the housing opening 4, only a seal with a suitable sealing element 18 is required to ensure a dust-free seal between the housing environment 3 and the housing interior 2 when the adapter module 9 is inserted, with connector 10 inserted in the socket of the contact element 5. In addition, the contact element 5 is covered by the adapter module 9 during operation and thus reliably protected from contamination. The sealing element 18 may be arranged in the housing through-opening 5 and/or on the adapter module 9, as shown schematically in FIG. 1.

The housing through-opening 4 may have a thread, a latching element and/or a recess for fastening the adapter module 9 to the housing 1. The housing through-opening 4 may be at least in sections conical and/or undersized with respect to an outer diameter of the adapter module 9. A potting compound may be arranged in the housing interior 2.

During initial operation of the blower filter unit 19 shown in a detail in FIG. 1, which is used to protect the equipment carrier in an environment 3 with substances, gases or gas mixtures hazardous to health, the adapter module 9 is inserted into the housing opening 4, the connector 10 of the adapter module 9 being inserted into the contact structure of the contact element 5. Via the connector 10 and the contact element 5, a unidirectional or bidirectional transmission of signals and data takes place, at least temporarily, between the components 13 arranged in the housing interior 2, in particular the control unit 13b and the blower motor of the air conveying unit 13e, and the operating status display 7 and the control element 8.

According to a special further development of the solution shown in FIG. 1, the operating status display 7 is integrated in the control element 8. In any case, it is essential that only one housing opening 4 is provided in which both the contact element 5, the operating status display 7 and the control element 8 are arranged. In this way, relatively simple means can be used to achieve a reliable seal between the housing interior 2 and the housing environment 3, which can preferably even be configured to be gas-tight.

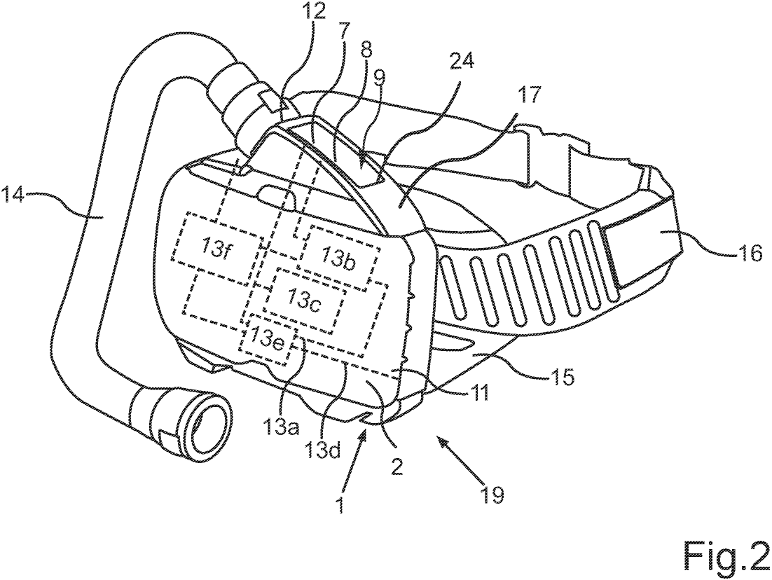

If the technical solution shown in FIG. 1 is used in a housing 1 of a blower filter unit 19, as shown in FIG. 2, the housing interior 2 contains above all hose lines for conveying air 13d, lines for transmitting data, signals and power 13a, a blower as an air conveying unit 13e, a voltage source in the form of an energy storage unit 13c configured as a battery (an accumulator), at least one filter 13f for treating the ambient air drawn in as required, and a control unit 13b for controlling the individual components 13. Air is drawn in from the environment 3 via an air inlet 11, purified of at least one substance hazardous to health by the at least one filter 13f and discharged from the housing interior 2 via an air outlet 12, to which a breathing air hose 14 can be connected. Finally, the device wearer is supplied with purified air via the breathing air hose 14 and a hose connector (not shown) arranged in a helmet or hood.

The adapter module 9 may have a transceiver unit via which data is at least partially transmitted wirelessly from an external data provision unit to the control unit 13a of the blower filter unit 19 arranged in the housing interior 2. The adapter module 9 may also comprise a line for transmitting data, signals and/or power between the connector 10 and an outer adapter contact element 20 that is arranged on the opposite side of the adapter module 9. The adapter module 9 may further comprise an identification unit, via which a proper fit of the adapter module 9 relative to the contact element 5 can be detected by the control unit 13b, and/or the identification unit may be provided such that an identity of the adapter module 9 at the housing through-opening 4 can be detected by the control unit 13b. The identification unit may be a transponder integrated into the adapter module 9.

If, after the end of operation, the battery 13c arranged in the housing interior 2 is to be recharged and supplied with electrical energy for this purpose and/or data is to be transferred between the internal control unit 13b and an external data provision unit, for example an update of the firmware is to be loaded, the adapter module 9 is removed from the housing through-opening 4 and a suitable connection is made between the contact element 5 arranged in the housing through-opening 4 and an external power supply and a data provision unit. When the blower filter unit 19 is started up again, the corresponding connector is released from the contact element 5 and the adapter module 9 is reinserted into the housing through-opening 4 so that the connector 10 of the adapter module 9 is again connected to the contact structure of the contact element 5.

FIG. 2 shows a blower filter unit 19 as carried by an equipment carrier in an area in which harmful substances, in particular dusts, and/or gases or gas mixtures hazardous to health may be present. The housing 1 of the blower filter device 19 is configured according to the invention. In particular, an adapter module 9 with an operating status display 7 and control elements 8 for switching the device 19 on or off or making special settings is provided, which is inserted into a housing through-opening of the housing wall. On a side facing the housing interior 2, the adapter module 9 has a connector 10 which is connected to a contact element 5 in the form of a socket with metallic contact pins for transmitting data, signals and power.

During operation, the blower filter unit 19 draws in contaminated air from the environment 3 via an air inlet 11 with the aid of an air conveying unit 13d arranged in the housing interior 2, conveys this air through hose lines 13c to a filter 13f and finally conveys the purified air to an air outlet 12. A breathing air hose 14 is connected to the air outlet 12, via which purified air is supplied to a hose connector of a helmet or hood worn by the device wearer (not shown). A control unit 13b is provided for the proper control of the components 13 arranged in the housing interior 2, in particular the air delivery unit 13d, which is connected to the operating status display 7 and the control elements 8 via the contact element 5 and the connector 10 of the adapter module 9 for the exchange of data and signals.

Further, the housing 1 has fasteners 15 by which a belt 16 is attached to the housing 1 of the blower filter device 19 so that the device 19 can be carried on the body by the device wearer.

While specific embodiments of the invention have been shown and described in detail to illustrate the application of the principles of the invention, it will be understood that the invention may be embodied otherwise without departing from such principles.

List of reference numbers

| | |
|---|---|
| 1 | Housing |
| 2 | Housing interior |
| 3 | Housing Environment |
| 4 | Housing opening |
| 5 | Contact element |
| 6 | Functional unit |
| 7 | Operating status display |
| 8 | Control element |
| 9 | Adapter module |
| 10 | Connector |
| 11 | Air inlet |
| 12 | Air outlet |
| 13 | Component |
| 13 a | Data, signal and/or power transmission lines |
| 13 b | Control unit |
| 13 c | Energy storage |
| 13 d | Elements for air guidance |
| 13 e | Air delivery unit |
| 13 f | Filter |
| 14 | Breathing air hose |
| 15 | Fastening element |
| 16 | Belt |
| 17 | Housing wall - housing wall structure |
| 18 | Sealing element |
| 19 | Blower filter unit |
| 20 | Outer adapter contact element |
| 22 | Outer surface of the adapter module |
| 24 | Outer edge wall contour |

What is claimed is:

1. A housing for accommodating electrical, electronic, electromechanical and/or electropneumatic components in a housing interior, the housing comprising:
a housing wall having at least one housing through-opening arranged between the housing interior and a housing environment;
a contact element arranged in the housing through opening; and
a functional unit comprising an energy storage unit, a drive unit, a fan motor, an operating status display and/or an control element for initiating a switch-on or switch-off process of at least one of the components arranged in the housing interior, the functional unit being configured to connect to at least one of the components in a state received by the housing through opening for the transmission of data, signals and/or power,
wherein the functional unit is comprised by an adapter module with a connector configured to be non-destructively detachably connected to the contact element arranged in the housing through opening and to establish a connection for transmitting the data, signals and/or energy, and
wherein in a state in which the adapter module connector is inserted into the housing opening, a dust-tight and/or liquid-tight and/or gas-tight seal is provided between the housing interior and the housing environment.

2. A housing according to claim 1, wherein the operating status display is integrated into the control element.

3. A housing according to claim 1, wherein an air inlet for supplying air into the housing interior and an air outlet for at least an indirect connection of a breathing air hose or tube, are provided on the housing wall.

4. A housing according to claim 1, further comprising a fastening element configured to provide an at least indirect fastening of a belt and/or a carrying strap to the housing wall.

5. A housing according to claim 1, wherein the housing through-opening has a thread, a latching element and/or a recess for fastening the adapter module to the housing.

6. A housing according to claim 1, wherein the housing through-opening is at least in sections conical and/or undersized with respect to an outer diameter of the adapter module.

7. A housing according to claim 1, further comprising a sealing element arranged in the housing through-opening and/or on the adapter module.

8. A housing according to claim 1, wherein the adapter module comprises a line for transmitting data, signals and/or power between the connector and an outer adapter contact element arranged on the opposite side.

9. A housing according to claim 1, wherein the contact element includes a wall structure socket portion and contacts, and the connector of the adapter module comprises a plug portion with contacts or the contact element includes a wall structure plug portion and contacts and the connector of the adapter module comprises a socket portion with contacts.

10. A blower filter unit comprising:
a housing for accommodating electrical, electronic, electromechanical and/or electropneumatic components in a housing interior, the housing comprising: a housing wall having at least one housing through-opening arranged between the housing interior and a housing environment; a contact element arranged in the housing through opening; a functional unit comprising an energy storage unit, a drive unit, a fan motor, an operating status display and/or an control element; and
components arranged in the housing interior,
wherein the control element is for initiating a switch-on or switch-off process of at least one of the components arranged in the housing interior, the functional unit being configured to connect to at least one of the components in a state received by the housing through opening for the transmission of data, signals and/or power,
wherein the functional unit is comprised by an adapter module with a connector configured to be non-destructively detachably connected to the contact element arranged in the housing through opening and to establish a connection for transmitting the data, signals and/or energy, and wherein in a state in which the adapter module connector is inserted into the housing opening, a dust-tight and/or liquid-tight and/or gas-tight seal is provided between the housing interior and the housing environment,
wherein the housing has an air inlet for supplying air from the environment into the housing interior and an air outlet for discharging air from the housing interior,
wherein the components arranged in the housing interior comprise data, signal and/or power transmission paths, a control unit configured to generate a control signal for actuating at least one of the components, an energy storage unit and, arranged between the air inlet and the air outlet, elements for guiding air, at least one air conveying unit and a filter for cleaning the air from the environment.

11. A blower filter unit according to claim 10, further comprising a potting compound arranged in the housing interior.

12. A blower filter unit according to claim 10, wherein the adapter module further comprises an identification unit, via which a proper fit of the adapter module relative to the contact element and/or to the housing through-opening and/or an identity of the adapter module can be detected by the control unit.

13. A blower filter unit according to claim 10, wherein the adapter module further comprises a transceiver unit for at least partial transmission and/or reception of wirelessly transmitted signals.

14. A process for operating a device, the process comprising the steps of:
providing a housing for the accommodation of various electrical, electronic, electromechanical and/or electropneumatic components in a housing interior with at least one housing through-opening arranged between the housing interior and a housing environment for accommodating a functional unit which can be connected or is connected to at least one of the components arranged in the housing interior for the transmission of data, signals and/or power;
providing an adapter module that comprises the functional unit, the adapter module having a connector that is configured to be non-destructively detachably attached to a contact element arranged in the housing through-opening such that a connection for transmitting the data, signals and/or power is established; and
connecting the connector to the contact element with a connecting of the adapter module to the housing wall.

15. A process according to claim 14, wherein the functional unit comprises at least one operating state display and an control element for switching on and off at least one of the components arranged in the housing interior, and data, signals and/or power are transmitted at least intermittently between at least one of the components arranged in the housing interior and the operating state display and/or the control element via the connector of the adapter module.
